(19) United States
(12) Patent Application Publication
(10) Pub. No.: US 2016/0216691 A1
(43) Pub. Date: Jul. 28, 2016

(54) HOLOGRAM PROJECTION APPARATUS USING RISLEY PRISM

(71) Applicant: Electronics and Telecommunications Research Institute, Daejeon (KR)

(72) Inventors: Hyun Eui KIM, Cheongju-si Chungcheongbuk-do (KR); Min Sik PARK, Sejong (KR); Jae Han KIM, Gwacheon-si Gyeonggi-do (KR); Jin Woong KIM, Daejeon (KR); Kyung Ae MOON, Daejeon (KR)

(21) Appl. No.: 15/002,873

(22) Filed: Jan. 21, 2016

(30) Foreign Application Priority Data
Jan. 28, 2015 (KR) 10-2015-0013443

(51) Int. Cl. G03H 1/22; G02B 27/00; G02B 13/00; G02B 26/08; G02B 3/00

(52) U.S. Cl. CPC G03H 1/2205; G03H 1/2294; G02B 26/0891; G02B 3/0081; G02B 13/0095; G02B 27/0093; G03H 2001/221; G03H 2001/2223; G03H 2001/2239

(57) ABSTRACT

A hologram projection apparatus using Risley prism is provided, the apparatus including a spatial light modulator (SLM) configured to output light incident from a light source through modulation into a hologram image, a light deflector configured to deflect the light output by the SLM according to a location of a pupil of a user, and a fixed-focus lens configured to project the hologram image on a focal plane using the deflected light.

### CROSS-REFERENCE TO RELATED APPLICATION

This application claims the priority benefit of Korean Patent Application No. 10-2015-0013443, filed on Jan. 28, 2015, in the Korean Intellectual Property Office, the disclosure of which is incorporated herein by reference.

### BACKGROUND

1. Field of the Invention

Embodiments relate to a three-dimensional (3D) hologram display system in a projection scheme to form a viewing window.

2. Description of the Related Art

A viewing angle of a hologram display may be determined based on a diffraction angle by a pixel distance of a spatial light modulator (SLM). In order for the SLM to provide a viewing angle in a level of a liquid crystal display (LCD), a pixel pitch within a micron is needed. However, manufacturing an SLM having a pixel interval within a micron may be difficult with current display manufacturing technology.

Accordingly, using the SLM having a compromise relationship between an image size and a viewing angle, holographic projection technology based on a viewing window has been developed to enlarge a size of a projected image and minimize a size of the viewing window to be a size of a pupil of a user.

However, in the holographic projection technology based on the viewing window, a viewing angle may be narrow when a location of the viewing window does not correspond to a location of a pupil of a user.

Therefore, a method of forming a viewing window according to a location of a pupil of a user has been requested.

### SUMMARY

According to an aspect, there is provided a hologram projection apparatus including a spatial light modulator (SLM) configured to output light incident from a light source through modulation into a hologram image, a light deflector configured to deflect the light output by the SLM according to a location of a pupil of a user, and a fixed-focus lens configured to project the hologram image on a focal plane using the deflected light.

The light deflector may be configured to deflect the light output by the SLM using a plurality of prisms rotatable around an optical axis.

The plurality of prisms may include at least one of a wedge prism, a Fresnel prism, or a Fresnel film composed of polyvinyl chloride (PVC).

The hologram projection apparatus may further include a variable-focus lens configured to form a viewing window by enlarging the hologram image projected by the fixed-focus lens.

The variable-focus lens may be a lens configured to adjust a focal distance by varying a radius curvature of a meniscus according to a voltage.

The hologram projection apparatus may further include a relay lens configured to transfer the light output by the SLM to the light deflector.

The relay lens may include a first relay lens configured to project a hologram image on a focal plane of the first relay lens using the light output by the SLM, a noise filter configured to filter noise of the projected hologram image, and a second relay lens configured to form the light from which the noise is removed on a focal plane of the second relay lens using the hologram image of which the noise is filtered.

According to another aspect of the present invention, there is provided a hologram projection apparatus including a spatial light modulator (SLM) configured to output light incident from a light source through modulation into a hologram image, a light deflector configured to deflect the light output by the SLM according to a location of a pupil of a user, a relay lens configured to remove noise from the light output by the SLM and transfer the light of which the noise is removed to the light deflector, a fixed-focus lens configured to project the hologram image on a focal plane using the deflected light, and a variable-focus lens configured to form a viewing window by enlarging the hologram image projected by the fixed-focus lens.

The light deflector may be configured to deflect the light output by the SLM using a first wedge prism and a second wedge prism rotatable around an optical axis.

The variable-focus lens may be a lens configured to adjust a focal distance according to a received voltage.

According to still another aspect of the present invention, there is provided a hologram projection system including a pupil tracking apparatus configured to track a location of a pupil of a user, and a hologram projection apparatus configured to modulate light output from a light source according to a hologram image and form a viewing window by deflecting the modulated light according to the location of the pupil of the user.

The pupil tracking apparatus may be configured to track the location of the pupil of the user using an image in which the user is photographed and transfer the tracked location of the pupil of the user to the hologram projection apparatus.

The hologram projection apparatus may include a spatial light modulator (SLM) configured to output light incident from a light source through modulation into a hologram image, a light deflector configured to deflect the light output by the SLM according to a location of a pupil of a user, and a fixed-focus lens configured to project the hologram image on a focal plane using the deflected light.

The light deflector may be configured to deflect the light output by the SLM using a plurality of prisms rotatable around an optical axis.

The hologram projection apparatus may further include a variable-focus lens configured to form a viewing window by enlarging the hologram image projected by the fixed-focus lens.

The variable-focus lens may be a lens configured to adjust a focal distance by varying a radius curvature of a meniscus according to a voltage.

The hologram projection apparatus may further include a relay lens configured to transfer the light output by the SLM to the light deflector.

The hologram projection system may include a hologram generating apparatus configured to generate a hologram image corresponding to a viewpoint of a user according to a location of a pupil of the user, and a hologram projection apparatus configured to form a viewing window by modulating light output from a light source according to the hologram image and deflecting the modulated light according to the location of the pupil of the user.

The hologram projection apparatus of the hologram projection system may include a spatial light modulator (SLM) configured to output light incident from a light source through modulation into a hologram image, a light deflector configured to deflect the light output by the SLM according to a location of a pupil of a user, a relay lens configured to remove noise from the light output by the SLM and transfer the light of which the noise is removed to the light deflector, a fixed-focus lens configured to project the hologram image on a focal plane using the deflected light, and a variable-focus lens configured to form a viewing window by enlarging the hologram image projected by the fixed-focus lens.

The light deflector may be configured to deflect the light output by the SLM using a plurality of prisms rotatable around an optical axis.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a hologram projection system according to an embodiment;

FIG. 2 is a block diagram illustrating a hologram projection apparatus according to an embodiment;

FIG. 3 illustrates an example of a hologram projection apparatus according to an embodiment; and

FIG. 4 illustrates an example of a light deflector of a hologram projection apparatus according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

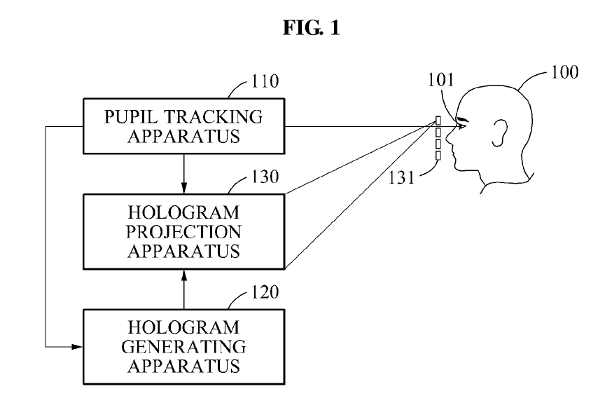

FIG. 1 illustrates a hologram projection system according to an embodiment.

The hologram projection system includes a pupil tracking apparatus 110, a hologram generating apparatus 120, and a hologram projection apparatus 130. For example, the hologram projection system may be a system for forming a viewing window in a Fourier scheme for a holographic display.

The pupil tracking apparatus 110 tracks a location of a pupil 101 of a user 100. The pupil tracking apparatus 110 may transfer the tracked location of the pupil 101 of the user 100 to the hologram generating apparatus 120 and the hologram projection apparatus 130.

For example, the pupil tracking apparatus 110 may extract a location of an eye of the user 100 from an image in which the user 100 is photographed. The pupil tracking apparatus 110 may track the location of the pupil 101 of the user 100 from the extracted location of the eye of the user 100.

The hologram generating apparatus 120 may generate a hologram image corresponding to a viewpoint of the user 100 according to the location of the pupil 101 of the user 110 received from the pupil tracking apparatus 110. For example, the hologram image may be a computer generated hologram (CGH).

The hologram generating apparatus 120 may transmit a hologram image corresponding to a viewpoint of the user 100 to the hologram projection apparatus 130.

The hologram projection apparatus 130 modulates light output from a light source according to a hologram image and forms a viewing window 131 on the pupil 101 of the user 100 by deflecting the modulated light according to the location of the pupil 101 of the user 100. The hologram projection apparatus 130 may control, based on a Risley prism structure, a direction of the modulated light to be projected and change a location of the viewing window 131 in high speed in response to a change of the location of the pupil 101 of the user 110.

The hologram projection apparatus 130 may have a structure in which a spatial light modulator (SLM) is located within a focal distance of a lens included in the hologram projection apparatus 130 and light output by the SLM forms a viewing window on another focal plane of the lens.

The hologram projection apparatus 130 may provide a three-dimensional (3D) holographic display having a wide viewing angle by deflecting, based on the Risley prism structure, light to form the viewing window 131 to correspond to the location of the pupil 101 of the user 100.

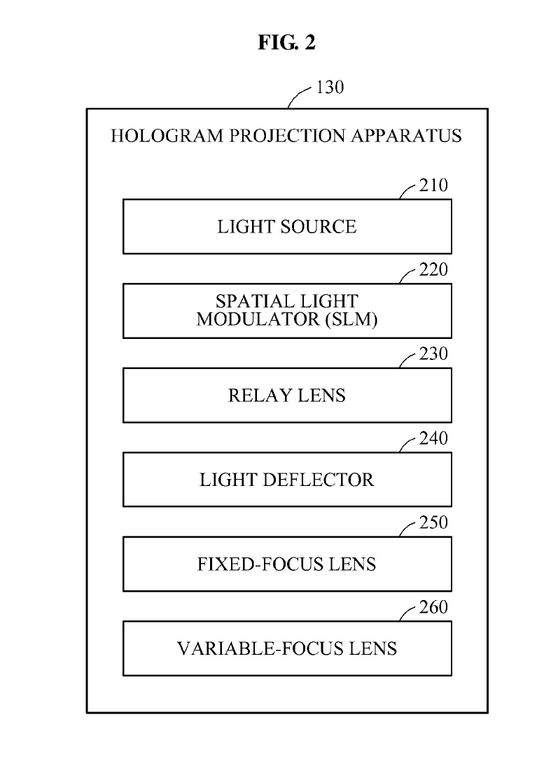

FIG. 2 is a block diagram illustrating a hologram projection apparatus according to an embodiment.

As described in FIG. 2, the hologram projection apparatus 130 includes a light source 210, a spatial light modulator (SLM) 220, a relay lens 230, a light deflector 240, a fixed-focus lens 250, and a variable-focus lens 260.

The light source 210 may output light for forming a viewing window. For example, the light source 210 may output light having plane wave on which collimation is performed.

The SLM 220 may output light incident from the light source 210 through modulation into a hologram image received from the hologram generating apparatus 120.

The relay lens 230 may remove noise from the light output by the SLM 220 and transfer the light of which the noise is removed to the light deflector 240. Here, the relay lens 230 includes a first relay lens to project a hologram image on a focal plane of the first relay lens using the light output by the SLM 220, a noise filter to filter noise of the projected hologram image on the first relay lens, and a second relay lens to form the light from which the noise is removed on a focal plane of the second relay lens using the hologram image of which the noise is filtered.

The light deflector 240 may deflect the light to be transferred through the relay lens 230 according to a location of a pupil of a user. Here, the light deflector 240 deflects the light output by the SLM 220 using a plurality of prisms rotatable around an optical axis. For example, the light deflector 240 may be a Risley prism structure including a first wedge prism and a second wedge prism rotatable around an optical axis. Also, the plurality of prisms included in the light deflector 240 may include at least one of a wedge prism, a Fresnel prism, or a Fresnel film composed of polyvinyl chloride (PVC).

The fixed-focus lens 250 projects the hologram image on a focal plane using the deflected light by the light deflector 240.

The variable-focus lens 260 forms a viewing window by enlarging the hologram image projected by the fixed-focus lens 250. The variable-focus lens 260 may be a lens to adjust a focal distance by varying a radius curvature of a meniscus according to a voltage.

When a distance between the user 100 and the hologram projection apparatus 130 is adjusted according to a location of the user 100, the hologram projection apparatus 130 may control the voltage input to the variable-focus lens 260 and adjust distance between the hologram projection apparatus 130 and a location at which the viewing window is formed.

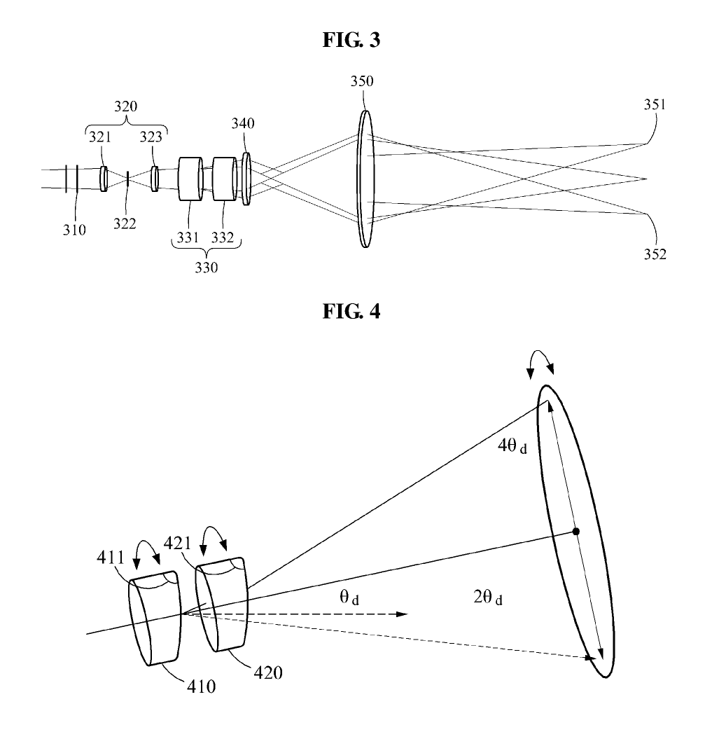

FIG. 3 illustrates an example of a hologram projection apparatus according to an embodiment.

Light output from a light source may be deflected according to an original hologram image by a spatial light modulator (SLM) 310. The light output from the light source may have a plane wave on which collimation is performed.

The light modulated by the SLM 310 may be incident to a first relay lens 321 included in a relay lens 320. As illustrated in FIG. 3, the light incident to the first relay lens 321 may project a hologram image on a focal plane of the first relay lens 321.

Here, a noise filter 322 disposed on the focal plane of the first relay lens 321 may filter noise from the hologram image projected on the focal plane of the first relay lens 321. For example, the noise filter 322 may be a space filter.

Also, the light that passes through the noise filter 322 may reimage a hologram image on a focal plane of a second relay lens 323 by the second relay lens 323. For example, the hologram image reimaged on the focal plane of the second relay lens 323 may be an SLM plane on which wavefronts formed by the light modulated by the SLM 310 are reimaged on the focal plane of the second relay lens 323 by a 4F system of the relay lens 320. The 4F system may be a standard system to transfer an image from a plane to another plane, using a pair of lenses.

A light deflector 330 deflects the light that passes through the second relay lens 323 using a first wedge prism 331 and a second wedge prism 332 according to a location of a pupil of a user. For example, when the pupil of the user is in a first location 351, the light deflector 330 may deflect the light that passes through the second relay lens 323 such that a location at which a viewing window is formed in a variable-focus lens 350 is to be the first location 351. Conversely, when the pupil of the user is moved to a second location 352, the light deflector 330 may deflect the light that passes through the second relay lens 323 such that the location at which a viewing window is formed in the variable-focus lens 350 becomes the second location 351.

Concisely, a viewing window may be formed on a pupil of a moved user by changing a direction of deflecting the light that passes through the second relay lens 323 by the light deflector 330 according to a change of a location of the pupil of the user.

The light deflected by the light deflector 330 may re-project the hologram image on a focal plane of a fixed-focus lens 340 by the fixed-focus lens 340. The re-projected hologram image may be a hologram image of which noise is removed by the noise filter 322.

The hologram image projected on the focal plane of the fixed-focus lens 340 may be enlarged by the variable-focus lens 350 and condensed at the location of the pupil of the user, thereby forming a viewing window. Here, the variable-focus lens 350 may adjust a focal point according to a distance between the hologram projection apparatus 130 and the user 100, such that the hologram image is condensed to form the viewing window. For example, when the user 100 approaches the hologram projection apparatus 130, the variable-focus lens 350 may adjust a focal distance to be relatively short, thereby forming the viewing window to be more adjacent to the hologram projection apparatus 130.

FIG. 4 illustrates an example of a light deflector of a hologram projection apparatus according to an embodiment.

As illustrated in FIG. 4, the light deflector 240 of the hologram projection apparatus 240 may be formed in a Risley prism structure in which a first wedge prism 410 and a second wedge prism 420 are disposed to share an identical optical axis.

Here, each of the first wedge prism 410 and the second wedge prism 420 may rotate 360 degrees around an optical axis. Also, the first wedge prism 410 and the second wedge prism 420 may have a characteristic that refracts light based on respective vertical angles and refractive indexes of medium.

Accordingly, the light deflector 240 may increase a degree of which light is deflected based on a structure of which the first wedge prism 410 and the second wedge prism 420 are sequentially disposed. The light deflector 240 may independently rotate the first wedge prism 410 and the second wedge prism 420 and control a vector direction to which light is deflected according to a degree generated by the first wedge prism 410 and the second wedge prism 420.

When a degree of light incident to the light deflector 240 is less than or equal to a threshold value, the light incident to the light deflector 240 is assumed to be a paraxial ray and a size of a deflection angle which is a degree of which the light is deflected, using Equation 1.

θd=α(n−1) [Equation 1]

In Equation 1, θd denotes a deflection angle, α denotes a vertical angle 411 of the first wedge prism 410 or a vertical angle 421 of the second wedge prism 420, n denotes a medium feature of the first wedge prism 410 and the second wedge prism 420.

According to an aspect of the present invention, a three-dimensional (3D) holographic display having a wide viewing angle may be provided, by forming a viewing window on a location of a pupil of a user and deflecting light for forming the viewing window according to the location of a pupil of a user, based on a Risley prism structure.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A hologram projection apparatus comprising:
a spatial light modulator (SLM) configured to output light incident from a light source through modulation into a hologram image;
a light deflector configured to deflect the light output by the SLM according to a location of a pupil of a user; and
a fixed-focus lens configured to project the hologram image on a focal plane using the deflected light.

2. The apparatus of claim 1, wherein the light deflector is configured to deflect the light output by the SLM using a plurality of prisms rotatable around an optical axis.

3. The apparatus of claim 2, wherein the plurality of prisms comprises at least one of a wedge prism, a Fresnel prism, or a Fresnel film composed of polyvinyl chloride (PVC).

4. The apparatus of claim 1, further comprising:
a variable-focus lens configured to form a viewing window by enlarging the hologram image projected by the fixed-focus lens.

5. The apparatus of claim 4, wherein the variable-focus lens is a lens configured to adjust a focal distance by varying a radius curvature of a meniscus according to a voltage.

6. The apparatus of claim 1, further comprising:
a relay lens configured to transfer the light output by the SLM to the light deflector.

7. The apparatus of claim 6, wherein the relay lens comprises:
a first relay lens configured to project a hologram image on a focal plane of the first relay lens using the light output by the SLM;
a noise filter configured to filter noise of the projected hologram image; and
a second relay lens configured to form the light from which the noise is removed on a focal plane of the second relay lens using the hologram image of which the noise is filtered.

8. A hologram projection apparatus comprising:
a spatial light modulator (SLM) configured to output light incident from a light source through modulation into a hologram image;
a light deflector configured to deflect the light output by the SLM according to a location of a pupil of a user;
a relay lens configured to remove noise from the light output by the SLM and transfer the light of which the noise is removed to the light deflector;
a fixed-focus lens configured to project the hologram image on a focal plane using the deflected light; and
a variable-focus lens configured to form a viewing window by enlarging the hologram image projected by the fixed-focus lens.

9. The apparatus of claim 8, wherein the light deflector is configured to deflect the light output by the SLM using a first wedge prism and a second wedge prism rotatable around an optical axis.

10. The apparatus of claim 8, wherein the variable-focus lens is a lens configured to adjust a focal distance according to a received voltage.

11. A hologram projection system comprising:
a pupil tracking apparatus configured to track a location of a pupil of a user; and
a hologram projection apparatus configured to modulate light output from a light source according to a hologram image and form a viewing window by deflecting the modulated light according to the location of the pupil of the user.

12. The system of claim 11, wherein the pupil tracking apparatus is configured to track the location of the pupil of the user using an image in which the user is photographed and transfer the tracked location of the pupil of the user to the hologram projection apparatus.

13. The system of claim 11, wherein the hologram projection apparatus comprises:
a spatial light modulator (SLM) configured to output light incident from a light source through modulation into a hologram image;
a light deflector configured to deflect the light output by the SLM according to a location of a pupil of a user; and
a fixed-focus lens configured to project the hologram image on a focal plane using the deflected light.

14. The system of claim 13, wherein the light deflector is configured to deflect the light output by the SLM using a plurality of prisms rotatable around an optical axis.

15. The system of claim 13, wherein the hologram projection apparatus further comprises:
a variable-focus lens configured to form a viewing window by enlarging the hologram image projected by the fixed-focus lens.

16. The system of claim 13, wherein the variable-focus lens is a lens configured to adjust a focal distance by varying a radius curvature of a meniscus according to a voltage.

17. The system of claim 13, wherein the hologram projection apparatus further comprises:
a relay lens configured to transfer the light output by the SLM to the light deflector.
